(19) United States
(12) Patent Application Publication
(10) Pub. No.: US 2018/0189784 A1
(43) Pub. Date: Jul. 5, 2018

(54) Systems and Methods

(71) Applicant: GENERATION NEXT SOLUTIONS, LLC, Annapolis, MD (US)

(72) Inventors: Alice A. Grabowski, Annapolis, MD (US); John V. Chiochetti, Annapolis, MD (US); Brian S. McGarvey, Annapolis, MD (US)

(73) Assignee: GENERATION NEXT SOLUTIONS, LLC, Annapolis, MD (US)

(21) Appl. No.: 15/860,337

(22) Filed: Jan. 2, 2018

Related U.S. Application Data
(60) Provisional application No. 62/440,522, filed on Dec. 30, 2016.
(60) Provisional application No. 62/440,511, filed on Dec. 30, 2016.
(60) Provisional application No. 62/440,506, filed on Dec. 30, 2016.
(60) Provisional application No. 62/440,500, filed on Dec. 30, 2016.

(51) Int. Cl. G06Q 20/38; H04L 29/08; G06Q 20/40; G06Q 20/22; H04L 29/06

(52) U.S. Cl. CPC G06Q 20/3829; H04L 67/104; G06Q 20/4014; G06Q 20/3278; H04L 63/10; G06Q 2220/00; G06Q 20/223

(57) ABSTRACT

Devices, systems, and methods securely authenticate a user, article, and/or device using an online platform or application use a multi-part cryptographic keying system and an imaging platform/device. A peer-to-peer information sharing/privacy system includes controls in a content sharing network. Devices, systems, and processes bias the purchasing power of organization or enterprise within a controlled/moderated venue to favor those more closely aligned with the interests and goals of the venue. Devices, systems, and processes are used for gaining or restricting access to an online network, environment, or communications channel, by requiring the transfer or exchange of a physical device, token, or data element. Devices, systems, and methods also integrate some or all of the forgoing together.

This application claims priority under 35 U.S.C. § 119 to U.S. Provisional App. Nos. 62/440,522, 62/440,511, 62/445,056, and 62/440,500, all filed on 30 Dec. 2016, by the inventors hereof, the entireties of which are incorporated by reference herein.

### BACKGROUND

### Field of Endeavor

The present disclosure relates to devices, systems, and methods for securely authenticating a user, article, and/or device using an online platform or application, a multi-part cryptographic keying system, and an imaging platform/device. It also relates to devices, systems, and processes useful as peer-to-peer information sharing/privacy controls in a content sharing network. Furthermore, it relates to devices, systems, and processes useful for biasing the purchasing power of organization or enterprise within a controlled/moderated venue to favor those more closely aligned with the interests and goals of the venue. Additionally, it relates to devices, systems, and processes useful for gaining or restricting access to an online network, environment, or communications channel by requiring the transfer or exchange of a physical device, token, or data element. It also relates to devices, systems, and methods that integrate some or all the forgoing together.

### Brief Description of the Related Art

Improvements in the state of the art in information protection and privacy management for average and vulnerable user populations in the ever increasingly connected world is a constant necessity. The volume of unprotected information available in the connected world, and the unscrupulous behavior of marketers and predatory behavior of criminals accessing this unprotected information, demands improvements in data protection and privacy.

### SUMMARY

According to a first aspect of the invention,

According to another aspect of the present invention,

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIGS. 1A-C illustrate example implementations using either a QR code or a uniquely ‘machine’ readable image (e.g., a statue of liberty image, the shape of an object) combined with an embedded NFC/RFID (electronically readable) for the A+B numerical data element;

FIG. 2 illustrates five-party fully linked relationships of bi-directional peer-to-peer content sharing, in which all parties have bi-directional content sharing relationships with all other parties;

FIG. 3 illustrates five-party limited linked relationships of peer-to-peer content sharing, in which some parties have only uni-directional content sharing relationships (A shares with E, but E doesn't share with A; C shares with A, but A doesn't share with C);

FIG. 4 illustrates a bi-directional peer-to-peer information sharing model between A & B;

FIG. 5 illustrates bi-directional peer-to-peer content filtering model between A & B with outgoing and incoming content filter controls;

FIG. 6 illustrates an exemplary multi-source attribute & perception model for reputation based score development;

FIG. 7 illustrates a table of exemplary data of the model of FIG. 6;

FIG. 8 illustrates a token generation request submitted by Party A to the network, Party A receives a collection of unique tokens for distribution to recipients;

FIG. 9 illustrates Party A (originator) giving Party B (recipient) a single unique token;

FIG. 10 illustrates Party B combining Party A's token (A#) with their own access credentials for the Network and submitting the combination to the network; through a secure keying algorithm, the unique pairing is linked to Party A and a secure one-way channel from A to B is established;

FIG. 11 illustrates an exemplary integrated system

FIG. 12 illustrates an exemplary system useful for implementing one or more of the modules described herein, as well as combined systems, at a high level; and

FIGS. 13A-L illustrate an example of stack management.

### DETAILED DESCRIPTION OF EXEMPLARY EMBODIMENTS

Referring to the drawing figures, like reference numerals designate identical or corresponding elements throughout the several figures.

The singular forms “a,” “an,” and “the” include plural referents unless the context clearly dictates otherwise. Thus, for example, reference to “a solvent” includes reference to one or more of such solvents, and reference to “the dispersant” includes reference to one or more of such dispersants.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

For example, a range of 1 to 5 should be interpreted to include not only the explicitly recited limits of 1 and 5, but also to include individual values such as 2, 2.7, 3.6, 4.2, and sub-ranges such as 1-2.5, 1.8-3.2, 2.6-4.9, etc. This interpretation should apply regardless of the breadth of the range or the characteristic being described, and also applies to open-ended ranges reciting only one end point, such as “greater than 25,” or “less than 10.”

This disclosure describes several aspects or modules which have stand-alone utility in numerous implementations, as well being usable together with each other in any combination of from two of the modules to all of the modules. Each of the individual modules will first be described, followed by exemplary systems in which two or more of the modules function together; however, the exemplary systems of combined modules described herein is not exhaustive of all the possible combinations.

Method for Authentication of a User, Article, and/or Device Through Pairing of Physical, Data, and/or Image

In general terms, methods described herein use a uniquely identifiable image (either of a class or one which is truly unique, through the use of steganographic methods) paired with an embedded digital code that if formed of a plurality, advantageously two, parts (e.g., A & B). In the exemplary embodiment of two parts, part A is a persistent value that, when paired with information content from the uniquely identifiable image, is used to verify authenticity of the article or device itself, and by inference the authenticity of the provider of the article or device. Additionally, Part B provides a single use functionality, in which the combined method uses parts A & B in tandem and paired with the uniquely identifiable image to provide a first-seen veracity of the article/device authentication. This two-part embedded digital code serves two functions in conjunction with the uniquely identifiable image: first, where parts A&B are combined, it can provide a high confidence ‘first event’ attestation; and, in subsequent attestation requests, part B is no-longer valid and the attestation is only of authenticity, and not of a first event.

These methods provide for securely authenticating a user, article, and/or device via, e.g., an online platform/application; it is not limited to an online platform, and can be used in a closed system or network environment. The implementation uses a multi-part cryptographic keying system coupled with an imaging platform or device.

By way of a non-limiting example, a physical article can be tested for authenticity and ‘first event.’ For example, consider a high value item purchased from a retailer. That object / device has a unique ‘as-a-class’ appearance that can be detected via the standard imaging capability of commonplace imaging devices, e.g., a mobile device (camera) to produce a data element, X. When that object/device also contains a machine readable unique code/number, A+B, that can be read via direct imaging or another independent channel (i.e., near field communication “NFC”, Bluetooth low energy “BLE”, or other electronic method) to produce a second data element, the two data elements, A+B & X can be used within an attestation environment/application to document the veracity of the article/ device and the prior transaction history as a unique ‘first event’, or not a first event, but still authentic versus ‘not authentic.’

This capability is embodied in a high value object/article/device that contains one of two ways of establishing article/device integrity:
(A) An image visible on the article is coded with optically readable/scannable data such as a matrix barcode (e.g., Quick Response—“QR”—code) or stenographically encoded image or shape. In this case, each image is truly unique and the attestation of authenticity is established by the unique data where the article is merely the carrier for the data.
(B) An Image-numerical pairing, where the image provides an ‘of-a-class’ identification (meaning, all otherwise identical objects have the same image) and additional unique numerical content can be derived in a physical or digital manner from the object/device/article, such as a QR code and/or RFID/NFC/BLE digital data element. In this case, the digital data element can be two numbers/a pair, in which a first part (part A) is the code used for ongoing authentication in companion with the image of the object/device/article, and a second part (part B) is a single use code to verify the ‘first event’ of the object/article/device.

This implementation offers a robust and unique methodology for high confidence user/article/device authentication.

### EXAMPLE

An exemplary method uses a uniquely identifiable image that can uniquely establish ‘of-a-class’ membership through the consistent, but authentic nature of the outward appearance of the object/article/device and provide a data element X. Second, the object/article/device includes two numerical values, A & B, which are advantageously not evident from the nature of the object itself, that can be recovered from the object/article/device via, e.g., NFC (using an embedded NFC device) that was encoded, at manufacture or distribution.

Through the unique combination of X, A & B, the attestation system can produce one of three fundamental results.
1) the object/article/device is not ‘of-a-class’ as expected and therefore should be considered unauthentic or potentially fraudulent.
2) the article is ‘of-a-class’ authentic by virtue of the successful test of X & A.
3) the article is both ‘of-a-class’ authentic and has never been tested before, which result implies original/‘first event’ authenticity of the object/article/device. This further attestation can be used to differentiate between ‘new’ versus ‘previously owned’, while still providing attestation of authenticity.

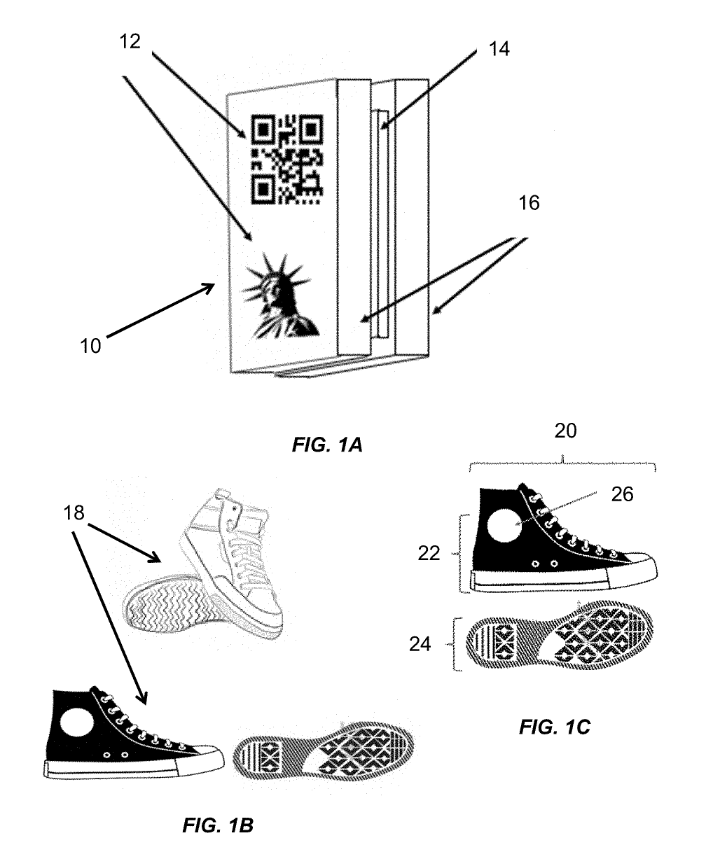

FIG. 1 illustrates an example implementation 10 using either a QR code or a uniquely ‘machine’-readable image (e.g., the Statue of Liberty image shown) 12 combined with an embedded NFC/RFID (electronically readable) device 14 carrying and for the A+B numerical data element, contained within or on a housing or packaging layer 16 of the object, or in/on the object itself.

For example, with reference to FIGS. 1A and 1C, an athletic shoe designer is concerned about high-value trademark and ‘limited edition’ shoes 18 with regard to counterfeit or illegal replicas. First, a unique design element of the shoe, e.g., a tread design, logo placement, and/or graphic features, when photographed and digitized, provides a unique ‘of-a-class’ identification of the article that is subsequently processed into a unique data element, X. Alternatively or further optionally, the graphics feature(s) included on the shoe may have an encoded image element, not readily apparent to the casual observer, e.g., a steganographically-encoded image that yields part or all of the data element X. Second, the physical design of the shoe incorporates an NFC tag (or other machine readable data storage element) embedded in the molded rubber of the sole (or other manufacturing component) that was encoded at the factory and/or distribution center with two (2) unique cryptographically verifiable codes, A & B. Optionally, in a broader aspect, it includes X, Y . . . m data elements for layered use.

By way of further example, a customer purchasing a pair of high-value athletic shoes, via a store kiosk or a mobile phone app, takes a photo of the shoe(s) in a suggested orientation, in a manner similar to the well-known way that a mobile-phone based check deposit user interface functions. One or more of the following can be used: a machine-based total image recognition 20 of the object (in this example, a shoe); one or more unique images or logos 26 appearing on the shoe; and/or one or more unique spacings/ratios 22 of graphic elements or portions of the shoe, which could include, for example, the tread pattern 24.

The digitized photo is sent to a processing system (could be resident in kiosk or app, but advantageously ‘in the cloud’—see FIG. 12) where it is processed to produce the unique data element X. The same kiosk or mobile phone app is used to scan the embedded NFC (or other machine-readable data storage element) to extract two (2) unique cryptographically verifiable codes, A & B. These codes are sent to the processing system where they are combined with X. The kiosk or mobile phone app verifies the resulting dataset and produces a cryptographically verified result (digital signature) that is then tested against a database 126 for three (3) facts: 1) Combined ‘digital signature’ is valid=article is authentic; 2) B+X one-time key test valid as first occurrence of this test=assumption of primary sale ‘new article’ versus a secondary sale ‘used article’; 3) combined ‘digital signature’ is NOT valid=article is non-authentic.

By way of a non-limiting example, the combination of keys is performed with hidden and non-hidden keys. The basic building block is the Pair (A,B), in which A and B are randomly generated cryptographic keys. The keys are of sufficient size to ensure low probability of collision, and are also of sufficient size to prevent brute force attacks; those of ordinary skill in the art are well acquainted with these parameters, and are therefore not further discussed herein. In this description both keys are randomly generated and are randomly paired, e.g., at the factory. The A key is sent to/with the end user (person, article, etc.). The Pairing is stored securely for later use. When a user registers the A key with the system the hidden key B is then accessed to be used to further access the system.

Another option when two keys are present at the end user is as follows: given a message and a public key, a cipher text is generated (e.g., via PGP, El-Gamal, and/or ECC). In this case, X would be the message, B would be the public key, and A would be the cipher text. In this alternative example, no private key is required, as there is a one-to-one mapping of the message to the cipher text. The user submits both A and X to the system, the system checks to ensure A transforms to X through B, cryptographically securely. For a one-time action, B would be substituted in the system to prevent further checks from passing, otherwise the pair can be used for verification repeatedly for other applications. For the case of the authenticated sale of used items, a new B could be used to generate a new A to transmit to the user either physically or electronically. For a more complex system, B can be generated as a proper Public Private Key pair. X is still used to generate the cipher text, but it is also used as a cipher text to generate a stored clear text message. Essentially, then, X is used both as a plain text message and a cipher text message. This allows X as a message to generate A as the cipher message so both items can be shared with the end user. But, the system has a way to verify the item has a matching keyset. To authenticate the device, however, the system must store X. Therefore, X is used to generate the unique ID for the device. X is used as a plain-text message and transformed into a cipher text message that becomes the unique ID of the device. In this case, the end user has a pair of keys, and the system has a pair of keys that are cryptographically linked, but A, B, X, and unique ID are all four different values.

This implementation can logically be extended from A & B to a series of n cryptographically verifiable codes (e.g. A, B, C . . . n) to ascribe a property or condition to the article (e.g., shoe) being evaluated. Similarly, the image-based ‘of-a-class’ data element can be extended to a series of ‘n’ unique data elements from different aspects or sensor types to provide more rigorous physical identification or to link multiple components of a set or system.

The combined dataset can be used to manage supply chain verification and/or authorization of use or sale. The authentication method is broadly applicable to article/item authentication for sale/re-sale and use/deployment of a component of a system or network. As in the shoe authenticity example, the extension goes well beyond a social network or even a content sharing network, and can be used to manage supply chain and limit advertising-based distribution/product release, for example. For example, if a new product is intended to be restricted in its sale to be synchronized with an event (i.e., a commemorative article) or a large advertising campaign (i.e., the release of the George Washington Limited Edition running shoe ONLY after Flash George completes the NY Marathon) to match supply/demand and uniform product release across a large distribution network. In addition to limiting release, this method could be used to manage counterfeit and unauthorized secondary markets for high-value items such as concert/festival tickets, designer fashions, and even high value electronics. (e.g., major networking equipment manufacturers have a serious problem with counterfeit and gray market equipment in customer networks. This method could be used for off network authentication and authorization for use).

The method can achieve a multi-level access/use control by layering or stacking the cryptographic keys, A, B, C, . . . n, that are extracted from the device via non-network ways (close proximity such as NFC or “out-of-band” for otherwise connected devices such as cell phones and network equipment), and maintaining the physical presence validation via the image based data element(s), X, Y, . . . m, that can only be obtained through close proximity and/or direct observation of the article/item.

Method for Peer-To-Peer Information Sharing/Privacy Controls in a Content Sharing Network

In general terms, this portion of the instant disclosure describes connections within a social network which are secure and uniquely linked between two parties that are within that social network. The link, once established, includes content-sharing controls or filters from the data owner to the data receiver, and from the data receiver applied to the data owner. These controls are bi-directional, but not necessarily uniform from Party A to Party B when compared to the controls from Party B to Party A. They thus embody both the ability for Party A to limit the type of content they share with Party B, and for Party B to limit the type of content they can ‘view’ from what Party A elected to share with Party B.

All data elements are maintained by the owner (e.g., within the social network, retained by the social network as ‘owned’ by an ‘owner’) and only a link to that data element can be shared by its owner with others within the social network. The individual action of sharing the link, combined with the data owner's controls over content types to be shared with a specific party and that specific party's controls over content type to be received from the data owner, creates a modified or filtered view of the data element based on the collection of information sharing controls or filters. These filters operate in a boolean AND manner, such that a content type of a shared data element is only visible to the recipient when the control for that content type is set to ‘allow’ for both the data owner and the recipient. If those controls are subsequently modified, the filtered view of the shared link changes appropriately.

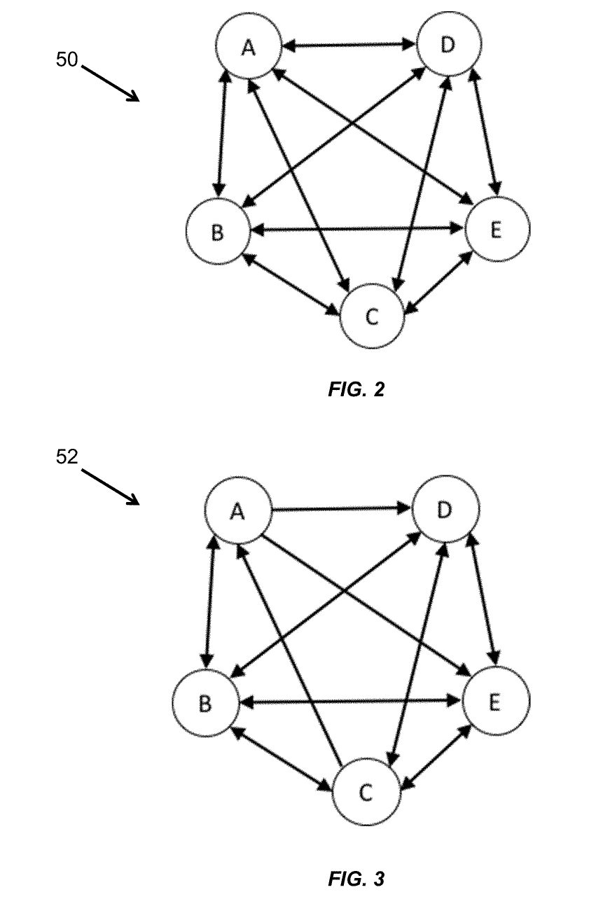

In a multi-party sharing environment, each data element is shared only ‘peer-to-peer’. Thus, with reference to FIG. 2, if there are parties A, B, C, D, & E involved in the environment 50, each of the parties must have a direct connection to each of the other parties. A↔B, A↔C, A↔D, A↔E, B↔C, B↔D, C↔D, etc. Each connection in the example of FIG. 2 has four sets of controls associated with it: the first party shares to the second party (A→B: outgoing content filter) and the second party shares to the first party (B→A: outgoing content filter); further, the second party views from the first party (incoming content filter) and the first party views from the second party (incoming content filter), as diagrammatically illustrated in FIG. 5.

The sharing controls can be represented as a linear function of each of the sharing parameters (e.g., of text, image, profile content, video, etc., and combinations thereof), e.g.,

F(A→B)=T(1)+I(0)+P(1)+V(0)+X(0)

where, in this example, A only shares Text (T) and Profile (P) content with B (indicated with the bit set to one), and not Images (I), Video (V), or any other data X (indicated with the bit set to zero). The converse relationship may be different, where

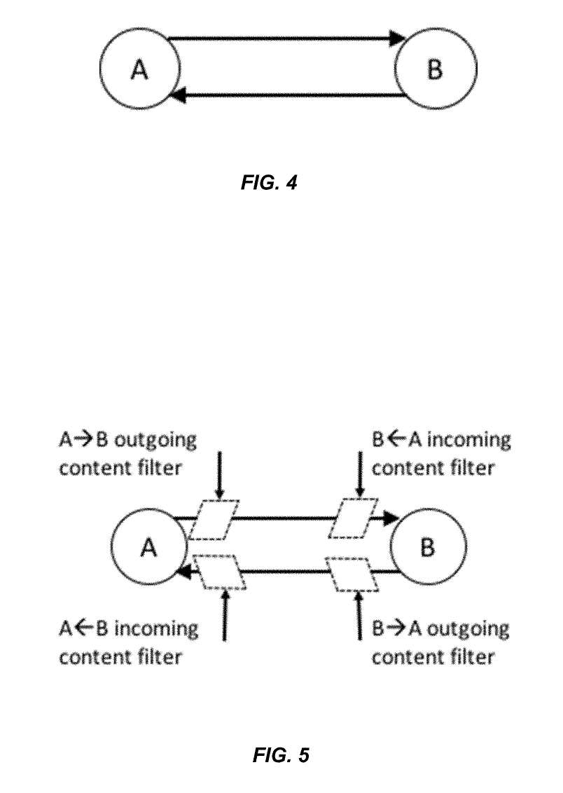

F(B→A)=T(1)+I(0)+P(1)+V(1)+X(0)

where B shares Text, Images, Profile content, and Videos with A; and not X. FIG. 3 thus illustrates an exemplary social network data sharing environment which embodies data sharing relationships among some or all of its members which are not uniformly bidirectional (e.g., A→C is not the same as C→A); more of the members' data sharing relationships can be less than uniformly bidirectional than suggested in FIG. 3. FIG. 4 illustrates the simplest case with bi-directional data sharing within the social network.

For example, a content owner, Bob, within a content sharing network (e.g., a social media network) has associated connections (friends): Alice, Ted & Carol. Bob selects different content sharing filters (controls) for each; for Alice, Bob has chosen to share ‘text’, ‘images’, ‘video’, but not ‘audio’ clips; for Ted, Bob has chosen to share ‘text’, ‘images’, but not ‘video’ or ‘audio’ clips; for Carol, Bob has chosen to share all (‘text’, ‘images’, ‘video’, and ‘audio’). Independently, Alice, Ted & Carol each have selected different content receiving filters (controls) for Bob: Alice has chosen to receive ‘text’ and ‘images’, but not ‘video’ or ‘audio’ clips; Ted has chosen to receive all ('text', ‘images’, ‘video’, and ‘audio’); Carol has chosen to receive ‘text’, but not ‘images’, ‘video’, or ‘audio’ clips.

Bob then constructs a data element (e.g., a post) to be shared with some of his associated connections (friends) in the network. The data element includes text, a picture, a short video, and audio clip, and that data element is entered into Bob's content repository. Bob selects two friends, Ted & Carol, but not Alice, with whom to share the data element. Two interim links to that data element are created, one for Ted and one for Carol. No link is created for Alice. Each interim link reflects Bob's choice of content types he's willing to share with Ted & Carol. Each interim link is further modified to reflect the content types each friend has chosen to receive.

Each interim link is then encoded with a unique key associated with the data element's allowed content types for sharing by Bob and receiving by each chosen friend. That uniquely keyed link is the only thing actually shared with Ted & Carol. Ted accesses the link provided to him, he is then able to view the ‘text’ and ‘images’ shared by Bob, but not the ‘video’ and ‘audio’; when Carol accesses the link provide to her, she is able to view the ‘text’ shared by Bob, but not the ‘images’, ‘video’ or ‘audio’; Alice receives no link and is not even aware that Bob has shared any content.

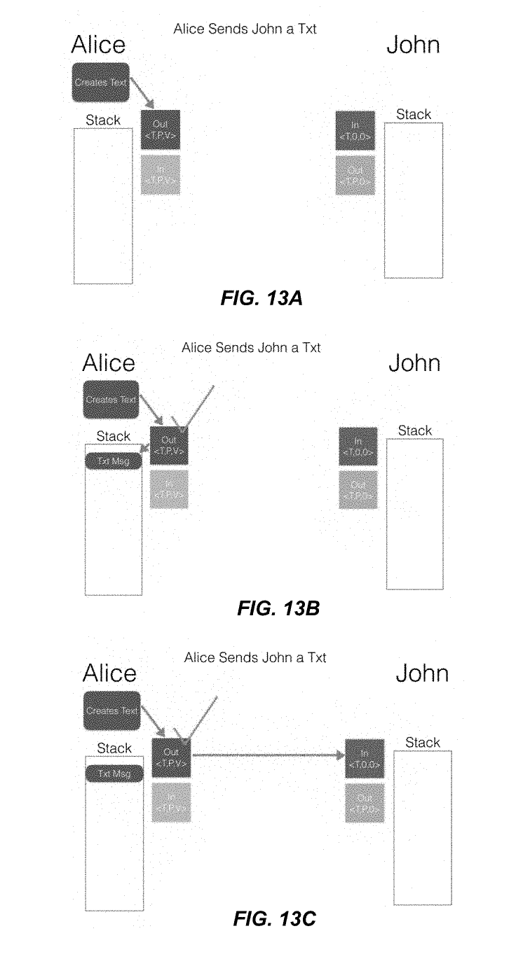

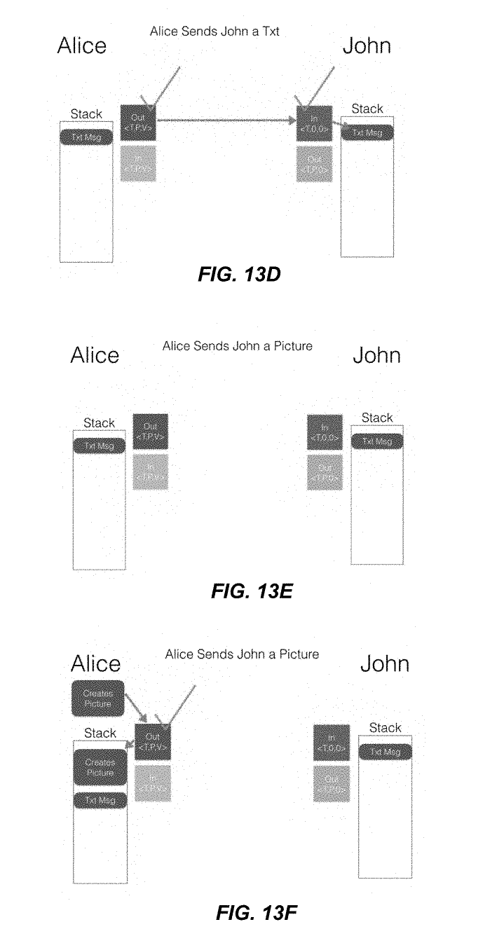

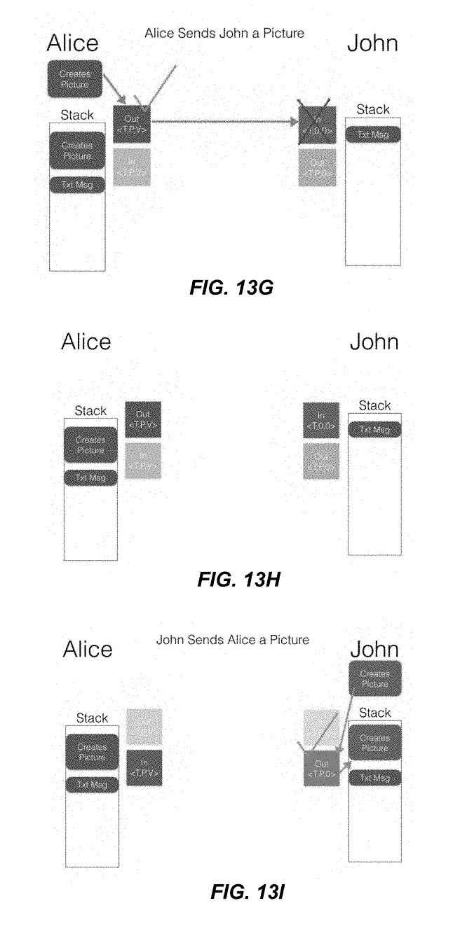

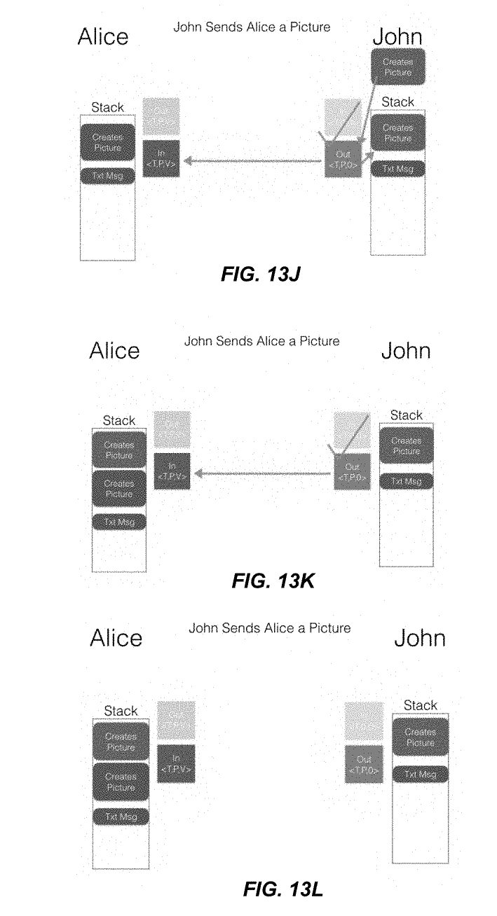

With reference to FIGS. 13A-L, an example of stack management useful in this context will now be described.

Alice decides she wants to send a text to John. First they have to exchange tokens. Alice will give John her token and John will give Alice his token. Once they scan it, they are now allowed to send each other text, pictures, and videos. But first they set their filters. Alice sets her filters that she is allowed to receive and send, text, pictures, and videos, but John says, I'm only allowed to receive text from Alice, and I'm only allowed to send text and pictures (FIG. 13A).

Alice wants to send John a text, so Alice creates the text and it goes to her out filter (FIG. 13B). Her out filter says ‘yes, you are allowed to send this.’ Now it goes into her stack saying, ‘yes this was sent.’

Now (FIG. 13C) the text is sent to John and John's in-filter says ‘yes, you are allowed to receive text from Alice’ and the text goes into John's stack (FIG. 13D). Alice has no way of knowing this, but that's ok.

Alice wants to send John a picture (FIG. 13E). Alice creates the picture and it goes to her out filter and the filter logic says ‘yes, you are allowed to send John pictures’, so the picture goes into her stack (FIG. 13F). The picture is sent to John, but John's in-filter says ‘no, I am not allowed to receive pictures from Alice’ (FIG. 13G), and therefore it does not go any further or into John's stack (FIG. 13H).

Now John wants to send Alice a picture (FIG. 13I), so John creates the picture, it goes to his out-filter and his out-filter's logic says ‘yes, you are allowed to send Alice pictures’ (FIG. 13J), and it goes into his stack. The picture is then sent to Alice (FIG. 13J), now Alice's in-filter says ‘yes, you are allowed to receive pictures from John’, and puts it in Alice's stack (FIG. 13K).

So now the end result is that Alice has John's picture, her picture and her text message, but John only has his picture and Alice's text message because of the filters (FIG. 13L).

The personal data stack described above is advantageously implemented as follows, and is based on privacy and personal control of one's own data. FIGS. 13A-13K, and their description, illustrate an exemplary method the filters work for end users as the users would see it. At the operational level, each user has two stacks: a personal data stack, and a shared data stack. Actual content is in the personal data stack, and only the user's own data is stored in their personal data stack. This allows for maximal control of data by the end user of their own data. Each entry in the personal data stack has a label, key, or address pointer associated with the data. In this context, a “key” refers to a crypto key, data address pointer, or other unique ID or label, as are well understood by routineers in the art.

The shared data stack is a stack that contains a list of keys, addresses, or labels that point to personal user data stacks. Due to the filtering techniques, there is no need for keeping track of any individual data filtering preferences. The filtering occurs prior to the key being added to the stack. For example, if Alice did not want to receive John's pictures she would set her filter to reject Pictures/ Images from John. As John sends mixed data of Text and Pictures to Alice. Only the text keys would be stored on Alice's stack. If at some later time Alice re-enables John's pictures only the new values would be placed on Alice's stack. Old pictures from the time when Alice blocked John would never be recalled.

### Example 1

When Alice gets a new device (PC, mobile device, etc.), she refreshes her data feed with her data stack. The background system queries each unique user for the data identified on her data stack. Only that data is pulled from other users, and pushed to her data feed.

### Example 2

At some point in time, Alice desires to remove a particular picture from her personal data stack. That image is deleted and the key points to a value that indicates data no longer exists. When John's refreshes his data feed, the image is automatically removed from the feed. A hash value for each data element is checked, and those that do not match can be checked for error or deletion. If deletion is indicated, the pointer in John's shared data stack is updated accordingly.

Optionally and/or alternatively, some or all the data in one or more of the stacks can instead be stored as an address pointer(s), and the data itself is randomized in a large data storage ‘bin’. In these alternative implementations, the individuals' data become anonymized by data crowd effects, allowing the hosting service of the ‘bin’ to mine the data without needing to tie a user to any particular data slice.

Reputation-Based Weighted Purchasing Power for Organizations or Enterprises

In general terms, this portion or module of the instant disclosure describes systems and methods useful for weighting or biasing the purchasing power of an organization or enterprise within a controlled/moderated venue to favor those more closely aligned with the interests and goals of the venue. A weighting system is created, e.g.., in a database, for acquisition capacity (e.g., in currency units, e.g., dollars) used to purchase a product or service to benefit the purchaser based on their affinity, support for, and/or alignment in goals or values with those of the seller.

By way of a non-limiting example, for advertisers wishing to market in a youth-centric venue, advertisers with a favorable ‘score’ for positive impact on youth (either through philanthropy, civic engagement, work/life balance, etc.) would have more ad-buying power per dollar than an advertiser with a less favorable score. The bias or multiplicand can be a complex function of that ‘score’ (“f(score)”) and its internal factors:

Buy$=Raw$×f(score)

Systems and methods described herein create a weighting system for acquisition capacity (dollars) used to purchase a product or service to benefit the purchaser, based on their affinity, support for, and/or alignment in goals or values with the seller. A formula is created/selected for weighting or biasing the purchasing power of a person, organization, or enterprise within a controlled/moderated venue to favor those organizations or enterprises more closely aligned with the interests and goals of the venue.

The aforementioned score is optionally, yet advantageously, compiled from objective rating organizations and/or by a board or panel of venue affiliates; optionally, a complex formula can be used which is based on relevant factors.

Exemplary Calculation Model

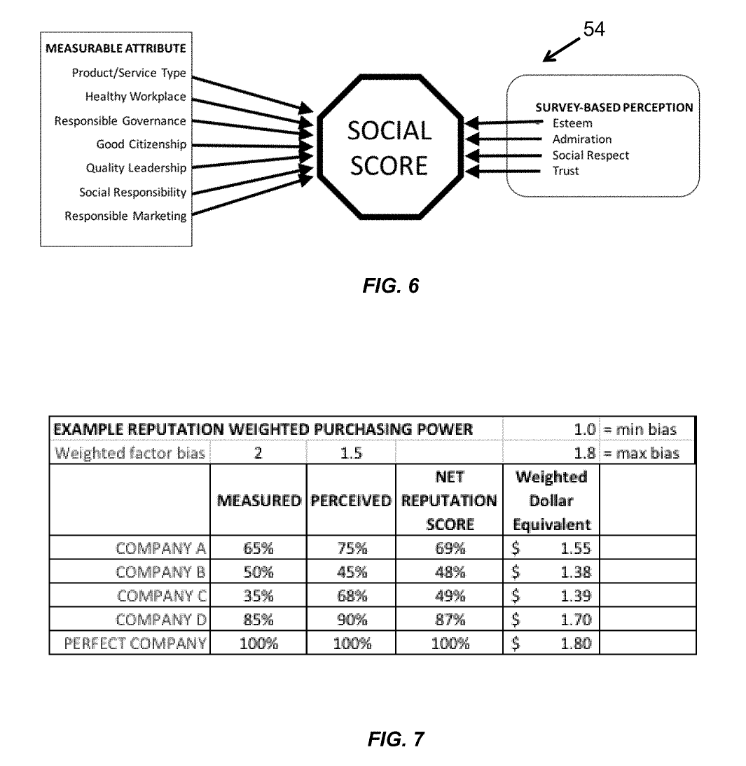

With reference to FIG. 6 and the table in FIG. 7:
Score=(multi-source formula for reputation assessment, e.g, as a value from 0-100%)
Score=Average [(measured_reputation×measured_factor_weight), (perceived_reputation×perceived_factor_weight)]*
Raw$=actual dollars spent
Buy$=relative purchasing dollars within the venue ad environment
min_bias=1.0 (this assumes linear variation from Score=0-100%)**
max_bias=1.5 (this sets the maximum advantage achievable)
Buy$=Raw$×((score×(max_bias−min_bias))+1)
   * this is limited to two factors for this example only, it can include any number of reputation measures and factor weights from 1 to N
   ** only used for this example, the actual variation can be a complex non-linear variation in the bias range or in the weighted factors

For example, the Toy Chest, a national chain of toy stores, is a youth focused enterprise whose founder and board have created a foundation for underprivileged kids, funded by a percentage of total revenue, that donates more than $5M/year to select boys' and girls' clubs in their communities that are in need of financial support. The merchandisers of the Toy Chest also carefully curate their products and suppliers to eliminate those that have poor records for exploitation of child labor in their overseas manufacturing.

The Toy Emporium, a national chain of toy stores, is focused on mass marketing and high volume sales whose board is solely focused on maximizing profits and minimizing costs. Their merchandisers are pressured to find the lowest cost suppliers.

The Toy Chest and the Toy Emporium both want to advertise in the National Youth Education Journal (NYEJ). The NYEJ board of directors has chosen to implement a Reputation-Based advertising model for their publication based on two factors: a) youth oriented philanthropic activities; and b) corporate purchasing/supplier philosophy regarding international child labor.

An independent reputation assessment organization, Reputations are Us (RaU), provides measured and perceived ratings for each of the national toy stores for the two factors (a, b) chosen by NYEJ. The data provided by RaU shows:

| | | |
|---|---|---|
| Toy Chest | a) 87% | b) 93% |
| Toy Emporium | a) 55% | b) 38% |

The NYEJ has chosen to weight the two factors differently; youth oriented philanthropy at 2.3 and Corporate purchasing philosophy at 1.3. The NYEJ also sets a bias range of 1.0-2.3.

The reputation-based advertising model produces a weighted dollar equivalent for advertisement purchasing for each toy store chain. Toy Chest: ((87% ×2.3)×(93%×1.3))/(2.3+1.3)=89.2% Net Reputation Score; Toy Emporium: ((55% ×2.3)×(38%×1.3))/(2.3+1.3)=48.9% Net Reputation Score. Given the bias range chosen (1.0-2.3), for every dollar spent on advertising in the NYEJ, the Toy Chest would receive $2.16 worth of ad purchasing power, while the Toy Emporium would receive $1.64 worth of ad purchasing power, over an unrated advertiser. Therefore, if each toy store chain wants to buy a ½ page ad in the NYEJ and the unrated cost of that ad is $1000, the Toy Chest would pay 5463 ($1000×(1/2.16)), Toy Emporium would pay $609 ($1000×(1/1.64)), and an unrated advertiser would pay $1000 ($1000×(1/1)). The result shows a benefit for advertiser participation, even if their rating is less than ideal for ideals of the NYEJ, thus encouraging advertiser participation.

Methods For Establishing Secure Access to an Online Environment Through the Physical Exchange of Device/Token/Data

In general terms, this portion of the instant disclosure describes systems and methods for gaining or restricting access to an online network, environment, or communications channel by requiring the transfer or exchange of a physical object, device, token, or data element. The manner of exchange or transfer requires the physical or electronic distribution of unique identifying components of the physical object, device, token, or data element. Once exchanged or transferred, these components, in conjunction with the recipient's private access credentials, establish a unique one-time pairing of the recipient's access credentials with the restricted network, environment, or communications channel. The token, once used to establish the unique access, is no longer valid for establishing access to that restricted network and only serves as a physical or data representation of the originator's public persona, name, or image.

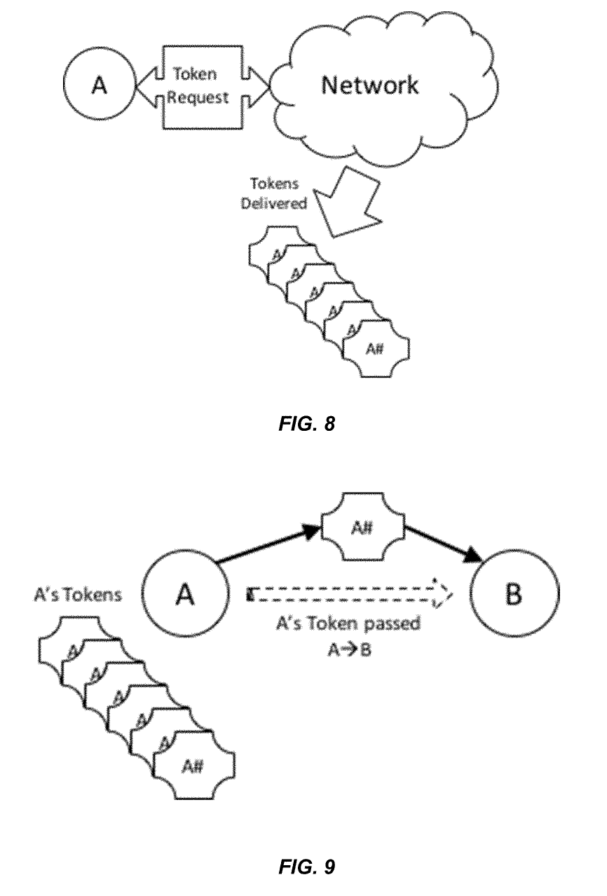

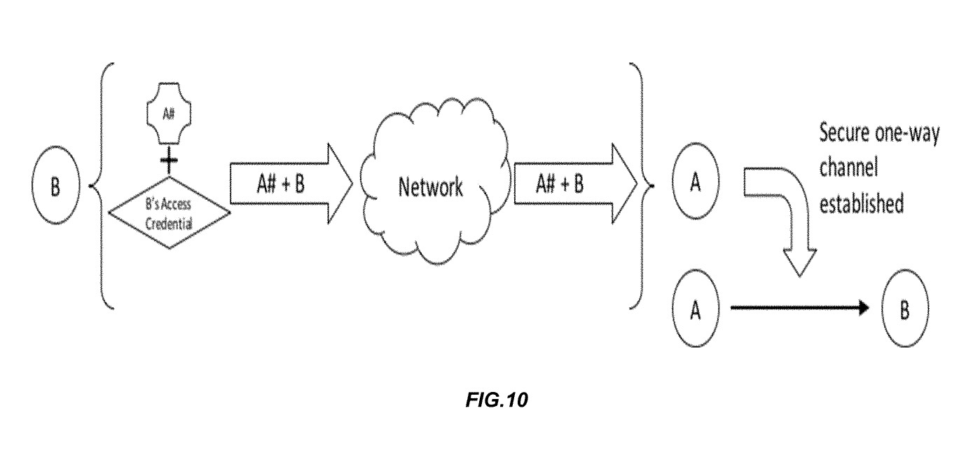

With reference to FIGS. 8-10, exemplary systems and methods include an originator who is the ‘owner’ of content within a private network, environment, or communication channel (collectively referred to as ‘the network’). The originator creates or causes to be created a series of unique one-time-use physical objects, devices, tokens, or data elements (collectively referred to as ‘tokens’) that advantageously have a visual and/or electronic key that, upon submission to the network, can be uniquely identified as belonging to the originator. The submission to the network is done by the recipient of the token, i.e., not the originator. The submission is required to be performed through a private access credential associated with the recipient within the network (e.g., a user id and ‘account’ or profile, or other similar unique private access credential). The paring of the token's unique key with the recipient's access credential creates a private channel within the network, between the originator and the recipient. That private channel then persists and the token is no longer valid and cannot be similarly used again by any user/member of the network. The private channel requires no disclosure to either party of any private information the information owner does not choose to explicitly share, thus establishing an information sharing channel that is protective of both the originator's and the recipient's identity details, but is deemed valid by token exchange and valid membership in the network. Therefore, this module emphasizes a privacy-protecting aspect that is not explicitly required, but can be particularly advantageous in many data exchange environments, including social networks.

The private channel that has been established can be electively maintained as a uni-directional path for content, for the originator to the recipient, or from the recipient to the originator. Full bi-directional integrity/security is only established if the originator and recipient reverse roles and a second token is passed in the reciprocal direction and submitted as the initial exchanged token, and is required to be performed through a private access credential associated with the recipient within the network (e.g., a user id and ‘account’ or profile, or other similar unique private access credential). That is, Token1 has originator 0 and recipient R, and Token2 has originator R and recipient 0.

Such methods can be used to establish information dissemination channels and/or information sharing channels. Furthermore, the channels are each established as unique secure and encrypted channels that may be further refined or filtered by additive controls.

With reference to the examples of FIGS. 8-10, Originator A generates one or more Tokens A, and it/they is/are physically distributed. When a Recipient B obtains a Token, Recipient B presents the Token with B's access credentials to the network. The network receives the combination of the Token with B's access credentials, and verifies that the Token is valid and has not yet been presented to the network; if both conditions are met, and B's network credentials are also valid for that network, then a private data channel is established between A and B, within the private network, and the Token is marked as ‘used’ in data within the private network. If B's credentials are invalid, or the Token is marked ‘used’ or otherwise not valid, the channel is not established.

Examples and Integrations

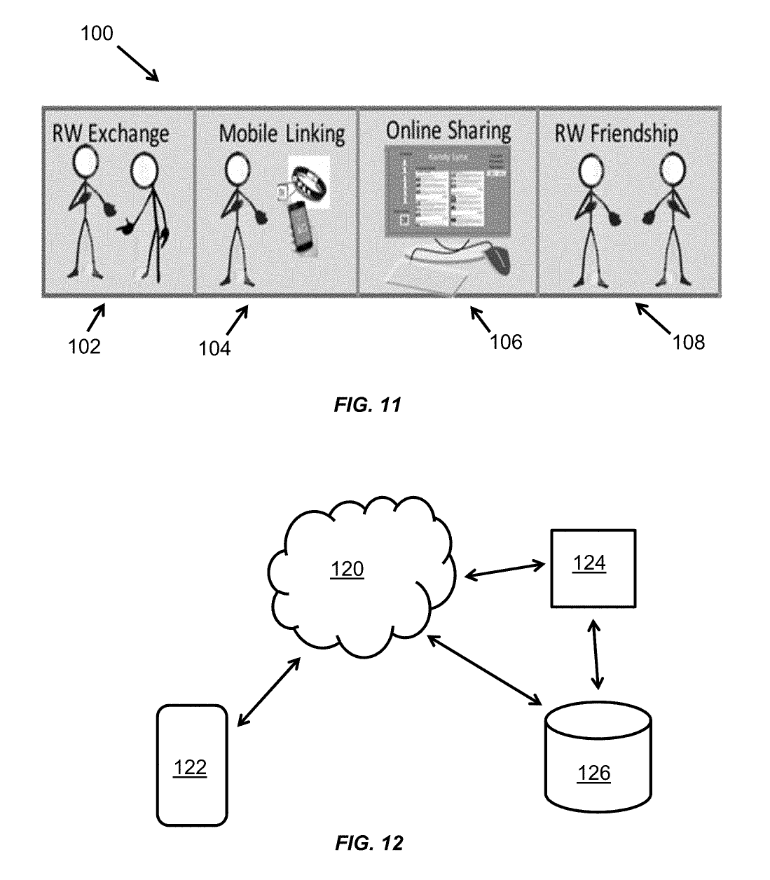

The illustrative cartoon of FIG. 11 depicts an exemplary integrated system and its basic high-level interactions.

Concerning the foregoing Method for Authentication of a User, Article, and/or Device Through Pairing of Physical, Data, and/or Image, a standalone use of this method would be to permit the authentication of an object or item via a computer application using a multi-part cryptographic keying system and an imaging device. The imaging device is used to capture a unique visual representation of a physical item, data set, or an image, which when decoded may contain one or more parts of the ‘keying’ system. Other parts of the keying system may be captured by other devices or systems, such as, free-space communications (e.g., NFC or infrared), or via direct digital input from either a standard IO device or a keyboard entry. By way of non-limiting examples, imaging devices can include digital cameras in mobile phones, tablets, laptops, or part of general purpose computers and the like.

In an exemplary integrated system 100, this method is applied to the reading of a miniQR code or similar visually encoded image that is affixed to a small physical item as a tag or ‘token’, as described elsewhere herein. In this exemplary system and method, it is treated as a one-time use, high integrity key for accessing a specific user's content on a private online platform. The token, in addition to the QRcode, itself has intrinsic value as a visually identifiable item associated with the private online platform and with the specific user of that platform. In the exemplary system, the token is given by a user/content author to another user/content recipient, and provides access to the author's content. It thus acts as a one-way key 102, meaning that by giving a token to a recipient, the recipient gets access to the author's content, but the author gets no access to the recipient's content. Examples of tokens include, but are not limited to, small physical items exchanged as ‘tokens’ of friendship or given as a sign of membership within a relationship or community of interest, such as collectable ‘coins’ or ‘pins’ of interest to fans of a musical artist or professional sports team that may visually display affinity or interest; or members and affiliates of a social group or activity group. Further examples include collectible items or wearable ‘bracelets’, ‘charms’, ‘pins’, ‘coins’ or ‘tags’ that are physically recognizable and include a encoded data element that is scannable (e.g. QR code) by a mobile phone camera or similar imaging device.

Concerning the Method for Peer-to-Peer Information Sharing/Privacy Controls in a Content Sharing Network, an exemplary standalone use of this system and method is for individually controllable content sharing channels between two distinct users of such a system. This allows for user-specific content filters (both send and receive) to be configured and updated individually based on the user-to-user (peer to peer) relationship within the content sharing network.

In an exemplary integrated system 100, this system and method 104 is used to control how content is sent and received within a specific user-to-user relationship. From the method for authentication description above, this sharing/privacy control method is employed to allow the author to control/limit what is shared with the recipient and the recipient to control/limit what is received from the author.

Concerning the Reputation-Based Weighted Purchasing Power for Organizations or Enterprises, an exemplary standalone use of this approach allows for buyers and sellers to influence the effective exchange rate for goods or services, based on an assessment of the relative alignment between the buying organization's mission or purpose and the seller's business practices, 106. Effectively giving more purchasing power to a seller, whose corporate policies, practices, profile, or other metrics are more aligned with those of the buying organization. This can thus operate as a way for the buying organization to preferentially buy from like-minded organizations, but also to scale or weight how ‘like-minded’ they are.

In an exemplary integrated system 100, this approach allows for the platform and the associated ideals of the target populations (i.e., positively youth oriented) to be supported by grading potential advertisers against a set of standards and giving preferential advertising buying power to those that score well against those standards. By way of a non-limiting example, an unrated or average scoring advertiser (A) may bid $10 for an ad; while a high scoring advertiser (B) may bid $8 for the same ad; using the weighted purchasing power approach, based on advertiser B's score(s) on factors determined by the platform, advertiser B's bid gets increased by 30% while advertiser A's gets no increase; so the effect of the bias gives advertiser B a $10.40 bid (a winning bid) over advertiser A. The effect is that well-aligned businesses will be more likely to get ads within the platform and in the long run, businesses may work harder to be well aligned with the factors that the platform weights more heavily. Such ads can then be displayed or otherwise served to some or all of the members of the network, as is well known for social media networks. The systems and methods are not restricted to social median networks, and can be implemented in numerous other environments, including print advertising, or any other medium that links an advertiser with a content source (e.g., publication) or network, as described elsewhere herein.

Concerning the Method for Establishing Secure Access to an Online Environment Through the Physical Exchange Device/Token/Data, an exemplary standalone application of this system and method requires that an online system owner/user must give a physical item to a prospective user of the online environment, and then the prospective user must use that item (object/device/token/data) to gain access to the online system. Non-limiting examples of such a physical item include a bracelet and the like, that is, small physical items exchanged as ‘tokens’ of friendship or given as a sign of membership within a relationship or community of interest, such as collectable ‘coins’ or ‘pins’ of interest to fans of a musical artist or professional sports team that may visually display affinity or interest; or members and affiliates of a social group or activity group, and other collectible items or wearable ‘charms’, ‘pins’, ‘coins’ or ‘tags’ that are physically recognizable and include a encoded data element that is scannable (e.g. QR code) by a mobile phone camera or similar imaging device.

In an exemplary integrated system 100, this physical device exchange 108 uses the exchange of an object to authenticate a user as the recipient of the physically exchanged object/device/token, and by pairing of a physical image (e.g., including a miniQR code) and data within the system assures secure access to the token giver's shared data.

For example, an organizational leader, such as a youth sports coach, desires to establish an information channel for the players and their parents/guardians. The coach establishes a Team account on the secure online system with the team name, graphics, and introductory content. The coach then is assigned, given or purchases 100 tokens. Those tokens each contain a logo of the team on one side and a unique miniQR code on the other: no two tokens have the same miniQR code. The coach associates the tokens as a group with the Team account, making them valid in the system.

The coach then distributes the tokens at the organizational meeting of the team, each player is given a number of tokens, which can be a plurality of tokens, based on the number of parents and/or other adults that may want or need the team information throughout the season. No other information is exchanged. The coach also provides basic instructions about the use of the tokens for accessing the online system.

Each player and player's parent downloads software (an app) for the online system to their mobile device or other computing device, sets up their personal account, and then scans the token's miniQR code with the (mobile) device's camera. Their personal account ID is combined with the token miniQR code and presented to the system for validation. If the miniQR code is valid in the system and associated with the team account, the system then establishes a channel from the team account to the parent or player who scanned the token. This channel is essentially a broadcast channel from the team to users who received and scanned a valid team token. No other information is exchanged, no personally identifying information (PII) is shared, the coach and team have no need or access to cell phone numbers or email addresses of players or parents. No parents or players have or need the coaches PII. The team now posts information to the system and it is disseminated to the players and parents in the manner they elect within the app. A player or parent may change or update their manner of dissemination at any time without involving the team or coach.

Aspects of the methods, processes, systems, and/or devices explained in this disclosure can include and/or constitute machine-executable component(s) embodied within machine(s), e.g., embodied in one or more computer-readable mediums (or media) associated with one or more machines. FIG. 12 illustrates one or more databases 126 for each of the modules described herein, a general purpose or special purpose computing device 124 including one or more of a processor(s), I/O components, displays, memory, which includes a set or sets of logical instructions in memory available to and executable by the processor to update the data in the database 126. The databases 126 can be a single database, separate databases for each module, or hybrids thereof. FIG. 12 also diagrammatically illustrates a computing device 122, which can be a mobile phone, tablet, laptop, and the like, which advantageously includes a (digital) camera as described herein. FIG. 12 also diagrammatically illustrates a network, which can be a private network or a public network (e.g., the internet) 120 to which the device 122, databases 126, and computing device 124 are selectively in communication to exchange data, as is very well understood by those of ordinary skill in the art.

Such components, when executed by the one or more machines, e.g., computer(s), computing device(s), virtual machine(s), etc. can cause the machine(s) to perform the operations described. In accordance with some embodiments of the disclosed subject matter, a preferably non-transitory computer-readable medium containing computer executable instructions that, when executed by a processor, cause the processor to perform a method steps described herein. For example, in some embodiments, devices can be implemented using any suitable genera-purpose computer or special purpose computer. As another example, a mobile device (e.g., mobile phone or tablet) may be implemented using a special purpose computer. Any such general-purpose computer or special purpose computer can include any suitable hardware useful for implementing the steps described herein for each of the individual methods and for any system or process combining two or more of the sub-systems described herein.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible considering the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

That which is claimed is:

1. A system useful for sharing data, the system comprising:
a set of logical instructions in memory configured to securely authenticate a user, article, and/or device using an online platform or application uses a multi-part cryptographic keying system and an imaging platform/device;
a set of logical instructions in memory configured to control peer-to-peer information sharing in a content sharing network;
a set of logical instructions in memory configured to bias the purchasing power of an organization within a controlled/moderated venue to favor those more closely aligned with a set of interests and goals of the venue; and
a set of logical instructions in memory configured to gain or restrict access to an online network, environment, or communications channel, including requiring transfer or exchange of a physical device, token, or data element prior to said gaining or restricting.

2. A system useful for authentication of a user, article, and/or device, the method comprising:
a set of logical instructions in memory configured to capture a unique visual representation of a physical item, data set, or an image with an imaging device;
a set of logical instructions in memory configured to decode said unique visual representation, to include first one or more parts of a keying system;
a set of logical instructions in memory configured to capture a second part of the keying system, optionally as free-space communications or via direct digital input from an IO device; and
a set of logical instructions in memory configured to authenticate the pair of first and second parts of the keying system.

3. A system useful for peer-to-peer information sharing with privacy controls in a content sharing network, the system comprising:
a set of logical instructions in memory configured to permit each user of said content sharing network to individually control content sharing channels between said user and any other single user of said content sharing network;
wherein said content sharing channels comprises a sending channel and a receiving channel for each peer-to-peer pair of said user and any other single user; and
wherein both said peer-to-peer sending channel and said peer-to-peer receiving channel is separately configurable within the content sharing network.

4. A system useful for reputation-based weighted purchasing power for buyer organizations, the system comprising:
a set of logical instructions in memory configured to represent a set of attributes of a seller of goods or services;
a set of logical instructions in memory configured to represent weighting factors for each of set of attributes of said seller, said weighting factors having been predetermined by said buyer;
wherein said weighting factors are based on attributes selected from the group consisting of corporate policies, practices, profile, and combinations thereof; and
a set of logical instructions in memory configured to apply said weighting factors to said seller attributes to produce a single compound weighting factor to apply to purchasing funds;
whereby buyers and sellers or goods or services are able to influence the effective exchange rate for said goods or services, based on an assessment of the relative alignment between the buyer's mission and the seller's business practices.

5. A system useful for establishing secure access to an online environment through the physical exchange of an object, the system comprising:
a physical object usable by a prospective user of the online environment to gain access to the online system, the object being physically recognizable and including an encoded data element scannable by an imaging device;
a set of logical instructions in memory configured to receive data from said imaging device representative of said object;
a set of logical instructions in memory configured to confirm the authenticity of said object based on said data representative of said object;
a set of logical instructions in memory configured to associate said data representative of said object with a set of user credentials for said online environment; and
a set of logical instructions in memory configured to grant access to data within said online environment based on the association of said data representative of said object with the set of user credentials.
